(19) United States
(12) Patent Application Publication
(10) Pub. No.: US 2008/0169063 A1
(43) Pub. Date: Jul. 17, 2008

(54) METHOD AND APPARATUS FOR ALIGNING AND BONDING FLEXIBLE DISPLAY PANEL

(75) Inventors: Huang-Sheng Fang, Tainan City (TW); Chin-Lung Liu, Kaohsiung County (TW); Chang-Chou Li, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/768,182

(22) Filed: Jun. 25, 2007

(30) Foreign Application Priority Data
Jan. 11, 2007 (TW) 96101096

(51) Int. Cl. B29C 65/48

(52) U.S. Cl. 156/299; 156/378

(57) ABSTRACT

A method for aligning and bonding a flexible display panel including following steps is provided. First, a lower flexible substrate and an upper flexible substrate are provided. The lower flexible substrate has a device array area. Next, the upper flexible substrate covers and is aligned to the device array area. Then, an edge of the upper flexible substrate is secured onto the lower flexible substrate. Afterward, the upper flexible substrate is lifted to expose the device array area, and a display medium is then provided thereon. Next, the upper flexible substrate is laid back over the device array area. Then a roller is used to bond the upper flexible substrate to the lower flexible substrate, such that the display medium is sealed therebetween. The method for aligning and bonding the flexible display panel is capable of being performed in a non-vacuum environment.

### CROSS-REFERENCE TO RELATED APPLICATION

This application claims the priority benefit of Taiwan application serial no. 96101096, filed Jan. 11, 2007. All disclosure of the Taiwan application is incorporated herein by reference.

### BACKGROUND OF THE INVENTION

1. Field of the Invention

The present invention relates to a method and an apparatus for aligning and bonding a display panel, and more particularly to a method and an apparatus for aligning and bonding a flexible display panel.

2. Description of Related Art

With the continuous progress in manufacturing integrated circuits and the growing demand for mobile communication, personal mobile communication devices have integrated a greater number of functions, such as versatile personal information management (PIM), entertainment function, and so forth. However, with the gradual increase in functions, the displays of the mobile communication devices may not be sufficient to display the increasing quantity of data in the limited display areas. Equipping the displays with larger display areas for data display and meeting the demands for small, compact and portable mobile communication devices underlie the arrival of flexible display devices which can be rolled up and carried around.

The technology of manufacturing the flexible displays has become a prominent indicator of prospective display technologies. In spite of continuous presence to the public, the flexible displays still cannot enter the market due to the potential pitfalls of high costs, unreachable requirements for related technologies, and unsatisfactory development of manufacturing equipments for mass production.

Filling and end-sealing of liquid crystals is one of the crucial technology processes in various technologies of fabricating liquid crystal displays. Conventionally, the liquid crystal injection process is performed through utilizing a vacuum infusion technique. Said method includes the following steps. First, an empty liquid crystal cell having a liquid crystal injection inlet is provided. The empty liquid crystal cell is formed by aligning and bonding an upper substrate to a lower substrate. Next, the empty liquid crystal cell is placed into a hermetic chamber, and a vacuum pump is implemented through evacuating the hermetic chamber. The liquid crystal injection inlet is then immerged in liquid crystals held in a liquid crystal vessel. And the interior pressure in the hermetic chamber is increased to the atmospheric pressure. Thereafter, the liquid crystals held in the liquid crystal vessel are injected by the atmospheric pressure, and, through a capillary action of the liquid crystal cell, the liquid crystal injection is completed.

Said liquid crystal injection process has drawbacks of wasting time and liquid crystals held in the liquid crystal vessel. Hence, one drop fill (ODF) process developed afterwards has become a more favorable manufacturing process. The ODF process includes dropping liquid crystals onto a lower substrate of a liquid crystal display (LCD) panel in a vacuum environment. Then, an upper substrate and the lower substrate of the LCD panel are aligned and bonded to each other. In comparison with the conventional liquid crystal injection process, the ODF process significantly reduces the cycle time. Moreover, all the liquid crystals employed in the ODF process are dropped onto the lower substrate, resulting in a reduction of liquid crystal material.

Nevertheless, both the liquid crystal injection process and the ODF process require the vacuum environment, and the vacuum pump should be implemented every time when said two process are to be performed, which wastes manufacturing time and impairs the efficiency of fabrication. In addition, a great amount of machine investment required by implementation of the vacuum pump process leads to a cost-up. Further, it is difficult to apply the vacuum pump process to a continuous fabrication of flexible display panels. For instance, flexible substrates can be coiled up as a belt or bent in conformity with production lines on account of flexibility. The coiled-up or the bent substrates in the belt shape can be moved with the production lines, and a plurality of the flexible display panels can be continuously manufactured, leading to a significant reduction of the cycle time. However, a large-sized vacuum space is required for placing the belt-like substrate as well as production-related components therein, and a long time lapse is necessary for implementing the vacuum pump process.

### SUMMARY OF THE INVENTION

The present invention provides a method for aligning and bonding a flexible display panel. Said method is capable of filling a display medium under normal pressure and of reducing air bubbles sealed in the display panel.

The present invention also provides an apparatus for aligning and bonding a flexible display panel appropriate for packaging and mass production thereof.

The present invention provides a method for aligning and bonding a flexible display panel, and the method includes the following steps. First, a lower flexible substrate and an upper flexible substrate are provided. The lower flexible substrate has a device array area. Next, the upper flexible substrate covers and is aligned to the device array area. Then, an edge of the upper flexible substrate is secured onto the lower flexible substrate. Afterward, the upper flexible substrate is lifted to expose the device array area, and a display medium is then provided thereon. Next, the upper flexible substrate is laid back over the device array area. Then a roller is used to bond the upper flexible substrate to the lower flexible substrate, such that the display medium is sealed therebetween.

The present invention further provides an apparatus for aligning and bonding a flexible display panel. Said apparatus is adapted to fill a display medium between a lower flexible substrate and an upper flexible substrate and to bond the lower flexible substrate to the upper flexible substrate. Here, the lower flexible substrate is adapted to move forward along a transmission path. The apparatus includes a stage, a conveyer, an alignment unit, a fixing unit, a substrate lifting mechanism, a display medium filling apparatus, and a roller. The stage is employed to support the lower flexible substrate and is adapted to move back and forth on the transmission path. The conveyer is disposed over the transmission path so as to convey the upper flexible substrate onto the lower flexible substrate. The alignment unit is disposed over the transmission path so as to have the upper flexible substrate aligned to a device array area of the lower flexible substrate. The fixing unit is disposed on the stage so as to secure an edge of the upper flexible substrate onto the lower flexible substrate. The substrate lifting mechanism is disposed over the transmission path and is adapted to lift the upper flexible substrate so as to expose the device array area. Moreover, the substrate lifting mechanism is adapted to move the upper flexible substrate over the device array area. The display medium filling apparatus is disposed over the transmission path so as to have the device array area filled with a display medium. The roller is disposed on the transmission path and is adapted to perform a rolling-pressing process on the upper flexible substrate.

In view of the foregoing, in the method for aligning and bonding the flexible display panel in the present invention, the air bubbles between the upper flexible substrate and the lower flexible substrate are expelled through the rolling-pressing process performed by the roller, such that the upper and the lower flexible substrates are bonded together under normal pressure. Hence, with use of the apparatus for aligning and bonding the flexible display panel in the present invention, the limitation on adopting the conventional apparatus under a vacuum environment is surmounted and the overall production efficiency is increased.

In order to the make the aforementioned and other objects, features and advantages of the present invention comprehensible, a preferred embodiment accompanied with figures are described in detail below.

### BRIEF DESCRIPTION OF THE DRAWINGS

FIGS. 1A through 1H are schematic flow charts depicting a method for aligning and bonding a flexible display panel according to one embodiment of the present invention.

FIG. 2A is a schematic view depicting a wall structure disposed on a lower flexible substrate disclosed in the method for aligning and bonding the flexible display panel according to another embodiment of the present invention.

FIG. 2B is a schematic view depicting another wall structure disposed on the lower flexible substrate disclosed in the method for aligning and bonding the flexible display panel according to another embodiment of the present invention.

FIG. 3A is a three-dimensional view depicting an apparatus for aligning and bonding a flexible display panel according to one embodiment of the present invention.

FIG. 3B is a lateral view of the apparatus depicted in FIG. 3A for aligning and bonding the flexible display panel.

FIG. 3C is a schematic view illustrating a movement of an upper flexible substrate and the lower flexible substrate in the apparatus depicted in FIG. 3A for aligning and bonding the flexible display panel.

FIG. 3D is a block diagram illustrating an electrical connection among parts of the components in the apparatus for aligning and bonding the flexible display panel depicted in FIG. 3A.

### DESCRIPTION OF EMBODIMENTS

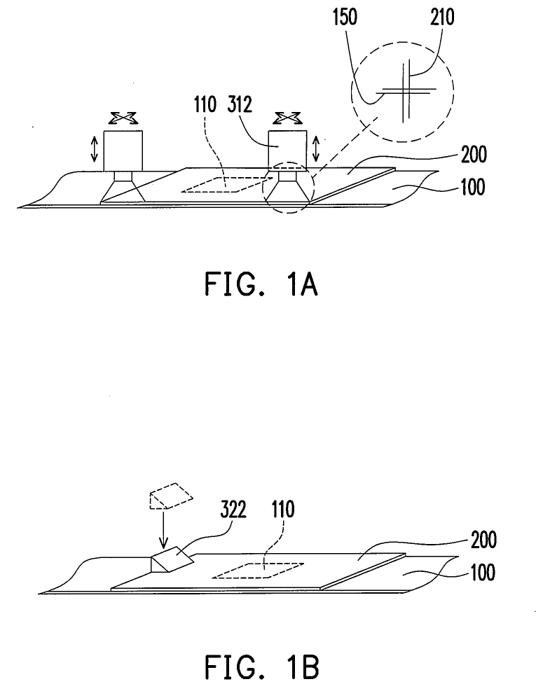

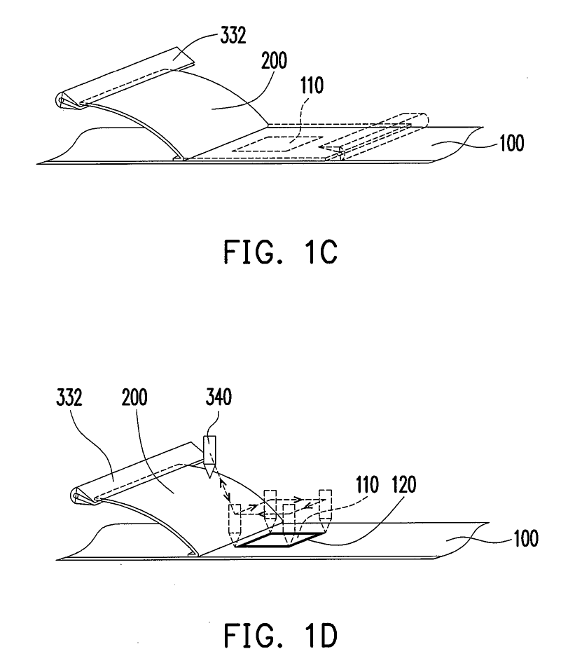

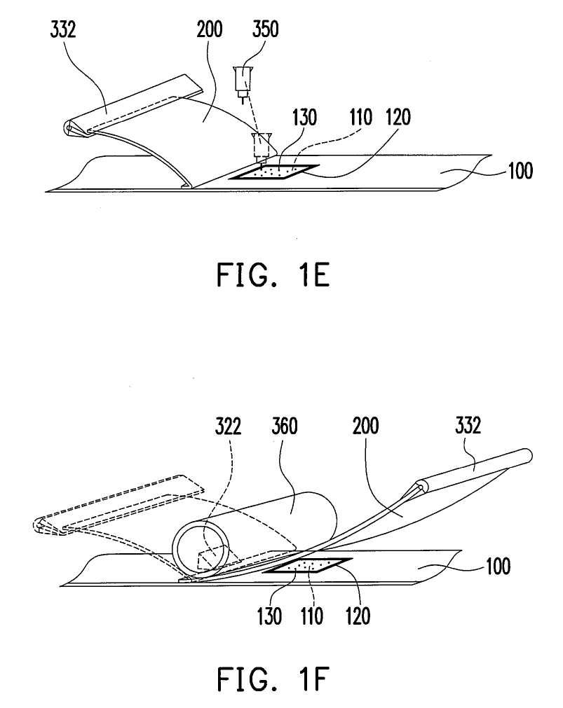

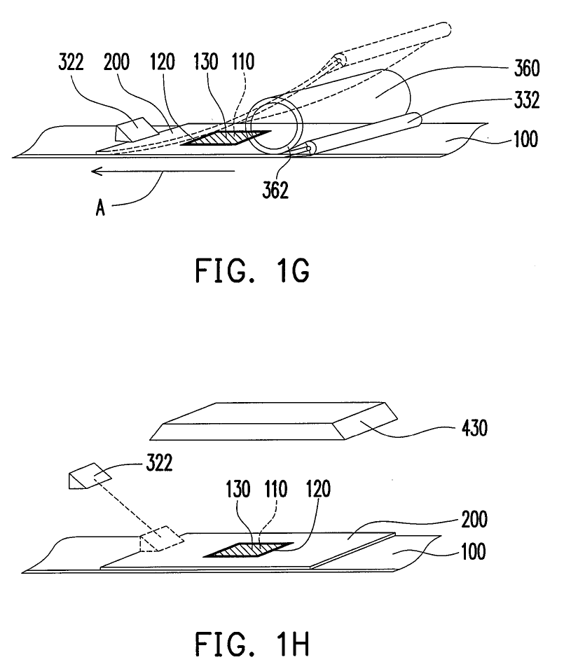

FIGS. 1A through 1H are schematic flow charts depicting a method for aligning and bonding a flexible display panel according to one embodiment of the present invention. Referring to FIG. 1A, a lower flexible substrate 100 and an upper flexible substrate 200 are provided. The lower flexible substrate 100 has a device array area 110. Next, the upper flexible substrate 200 covers and is aligned to the device array area 110. As shown in FIG. 1A, a precise alignment technology such as image recognition technology allows the upper flexible substrate 200 to be aligned to the device array area 110 according to the present embodiment. Particularly, the lower flexible substrate 100 and the upper flexible substrate 300 may be provided with alignment marks 150 and 210, respectively. Then, an image sensor 312 may be utilized to detect if the alignment marks 150 and 210 are accurately aligned, so as to precisely align the upper flexible substrate 200 to the device array area 110 of the lower flexible substrate 100. In an embodiment of the present invention, the lower flexible substrate 100 and the upper flexible substrate 200 are transmitted by a conveyor. In an alternative embodiment of the present invention, the lower flexible substrate 100 and the upper flexible substrate 200 are transmitted in a manner of patching or a manner of reel to reel.

Then, referring to FIG. 1B, an edge of the upper flexible substrate 200 is secured onto the lower flexible substrate 100. For example, a press bar 322 is used to press the edge of the upper flexible substrate 200 onto the lower flexible substrate 100 according to the present embodiment, while a clamp may also be employed to clamp the edge of the upper flexible substrate 200 onto the lower flexible substrate 100 according to other embodiments of the present invention.

Afterward, referring to FIG. 1C, the upper flexible substrate 200 is lifted to expose the device array area 110. For example, the upper flexible substrate 200 may be lifted through vacuum suction or clamping according to the present embodiment. In FIG. 1C, a clamp 332 is adopted to clamp and lift the upper flexible substrate 200. It should be noted that the upper flexible substrate 200 is lifted for smoothly performing a subsequent process of filling a display medium.

Next, referring to FIG. 1D, a sealant 120 is coated at a periphery of the device array area 110. For example, a dispenser 340 may be used to coat the sealant 120 at the periphery of the device array area 110 in the present embodiment. According to one embodiment of the present invention, a material of the sealant 120 includes light curable material, thermal curable material, photoresist material, or a compound that is self-curable under normal temperature.

Next, referring to FIG. 1E, a display medium 130 is provided on the device array area 110. Here, the sealant 120 encompasses the display medium 130 to confine the display medium 130 to the device array area 110. For example, the device array area 110 may be filled with the display medium 130 through one drop fill (ODF) process, coating, or inkjet printing according to the present embodiment. It is noted from FIG. 1E that a display medium filling apparatus 350 is utilized to have the device array area 110 filled with the display medium 130 in the present embodiment. Moreover, the display medium 130 adopted in the present embodiment may include liquid crystal medium such as semectic liquid crystals, nematic liquid crystals, cholesteric liquid crystals or discotic liquid crystals, or include particle medium such as electrophoretic particles or Rotating sphere.

Referring to FIG. 1F, the upper flexible substrate 200 is conveyed over the device array area 110 so as to enable a roller 360 to subsequently perform a rolling-pressing process on the upper flexible substrate 200. For example, the upper flexible substrate 200 may be conveyed over the device array area 110 by vacuum suction or clamping according to the present embodiment. As shown in FIG. 1F, the clamp 332 may be adopted in the present embodiment to clamp the upper flexible substrate 200 and convey the same over the device array area 110.

Then, referring to FIG. 1G, the roller 360 is used to bond the upper flexible substrate 200 to the lower flexible substrate 100, such that the display medium 130 is sealed therebetween. For example, the lower flexible substrate 100 may move the upper flexible substrate 200 along a transmission path A, such that the upper flexible substrate 200 passes through the roller 360. During the passage of the upper flexible substrate 200 through the roller 360, the roller 360 bonds the upper flexible substrate 200 to the lower flexible substrate 100 by performing the rolling-pressing process. In addition, the roller 360 includes a soft-surface layer 362 which is adapted to contact the upper flexible substrate 200 in the rolling-pressing process and to prevent a surface of the upper flexible substrate 200 from damaging on account of performing the rolling-pressing process. After the roller 360 rolls and presses the upper flexible substrate 200, air bubbles between the upper flexible substrate 200 and the lower flexible substrate 100 are expelled under normal pressure. Thus, according to the present embodiment, the method for aligning and bonding the flexible display panel may be performed under normal pressure, and the manufacturing cycle time can further be effectively reduced.

In the present embodiment, a curing apparatus 430 is required for curing the sealant 120 given that the material of the sealant 120 includes light curable material, thermal curable material or photoresist material. Specifically, as the material of the sealant 120 is the light curable material or the photoresist material, the curing apparatus 430 may be a light source. Contrarily, as the material of the sealant 120 is the thermal curable material, the curing apparatus 430 may be a heater. However, according to other embodiments of the present invention, if the material of the sealant 120 is a compound that is self-curable under normal temperature, the curing apparatus 430 is not required.

In the present embodiment, as the sealant 120 is cured, the press bar 322 can then be removed. And the steps included in the method of aligning and bonding the flexible display panel according to the present embodiment are all completed.

It should be noted that one upper flexible substrate 200 is employed to cover only one device array area 110 according to the present embodiment, while one upper flexible substrate 200 may be utilized to cover a plurality of the device array areas 110 of the lower flexible substrate 100 according to other embodiments in the present invention.

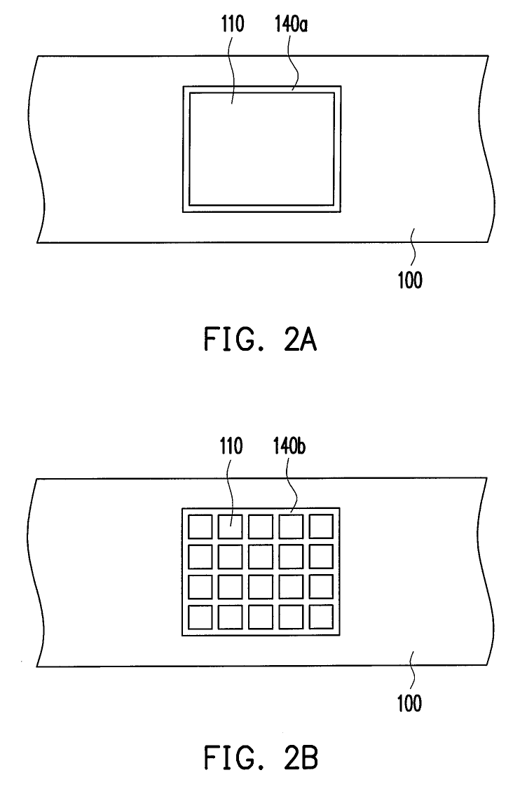

FIG. 2A is a schematic view depicting a wall structure disposed on a lower flexible substrate disclosed in the method for aligning and bonding the flexible display panel according to another embodiment of the present invention, and FIG. 2B is a schematic view depicting another wall structure disposed on the lower flexible substrate disclosed in the method for aligning and bonding the flexible display panel according to another embodiment of the present invention. Please refer to FIGS. 2A and 2B. The method for aligning and bonding the flexible display panel disclosed in the present embodiment is similar to the method provided by the former embodiment shown in FIGS. 1A through 1H, and the difference therebetween is described hereinafter. According to the present embodiment, a wall structure 140a (as shown in FIG. 2A) or another wall structure 140b (as shown in FIG. 2B) is initially disposed on an upper surface of the lower flexible substrate 100 in the method for aligning and bonding the flexible display panel. The wall structure 140a surrounds a device array area 110 while the wall structure 140b divides the device array area 110 into a plurality of areas. The periphery of the wall structure 140b surrounds the device array area 110 as well.

Note that it is not necessary to coat a sealant 120 (as shown in FIG. 1D) at the periphery of the device array area 110 in the present embodiment but to coat an adhesive on the wall structure 140a or 140b after a display medium 130 as shown in FIG. 1E is provided on the device array area 110. In particular, a dispenser 340 as shown in FIG. 1D may be adopted to coat the adhesive which may include light curable material, thermal curable material, or a compound that is self-curable under normal temperature according to the present embodiment. On the condition that the adhesive is the light curable material or the thermal curable material, the method for aligning and bonding the flexible display panel disclosed in the present embodiment may cure the adhesive with use of an curing apparatus 430 (as shown in FIG. 1H) after an upper flexible substrate 200 and the lower flexible substrate 100 are bonded together by a roller 360.

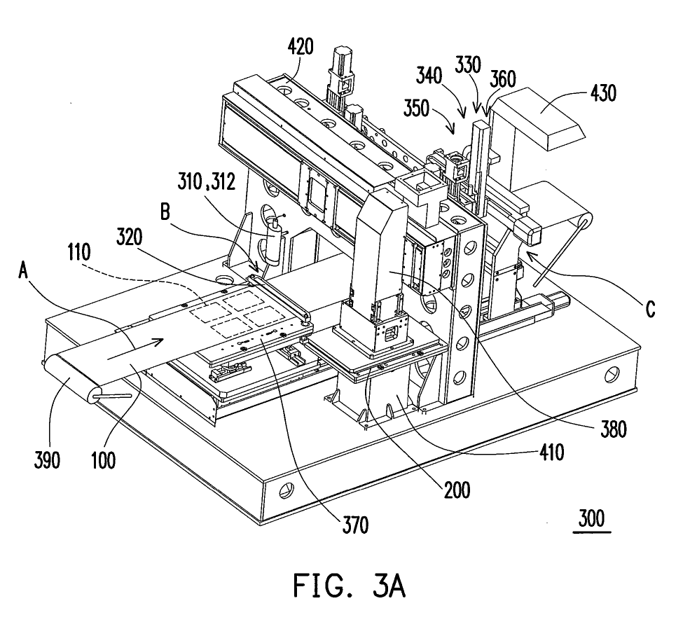

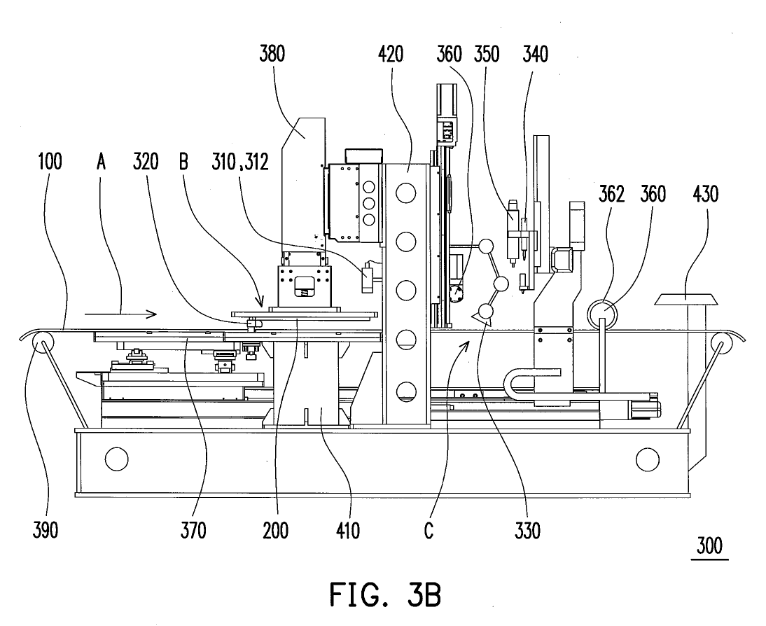

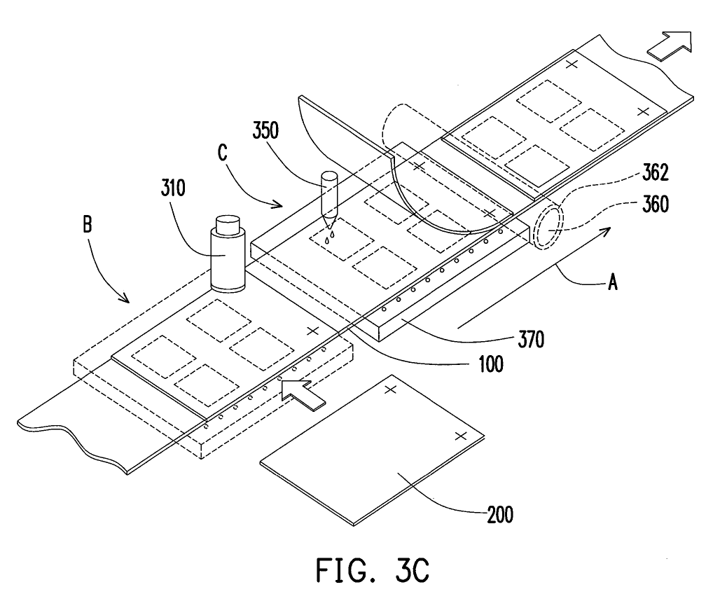

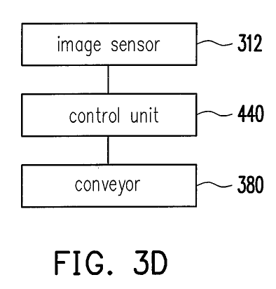

FIG. 3A is a three-dimensional view depicting an apparatus for aligning and bonding a flexible display panel according to one embodiment of the present invention. FIG. 3B is a lateral view of the apparatus depicted in FIG. 3A for aligning and bonding the flexible display panel. FIG. 3C is a schematic view illustrating a movement of an upper flexible substrate and the lower flexible substrate in the apparatus depicted in FIG. 3A for aligning and bonding the flexible display panel. Referring to FIGS. 3A through 3C, an apparatus 300 for aligning and bonding a flexible display panel disclosed in the present embodiment may be used to perform said method for aligning and bonding the flexible display panel. Said apparatus 300 includes a stage 370, a conveyer 380, an alignment unit 310, a fixing unit 320, a substrate lifting mechanism 330, a display medium filling apparatus 350, and a roller 360.

The stage 370 is employed to support a lower flexible substrate 100 and is adapted to move back and forth on a transmission path A of the lower flexible substrate 100. According to the present embodiment, the lower flexible substrate 100 is adapted to move forward along the transmission path A, and the stage 370 can be moved to an alignment position B and a filling position C on the transmission path A. The filling position C is located in front of the alignment position B. Here, the alignment position B is established to have an upper flexible substrate 200 aligned to the position of a device array area 110 of the lower flexible substrate 100, while the filling position C is set to enable a display medium 130 (referring to FIG. 1E) to fill the device array area 110.

The conveyer 380 is disposed over the transmission path A so as to convey the upper flexible substrate 200 onto the lower flexible substrate 100. The alignment unit 310 is disposed over the transmission path A so as to have the upper flexible substrate 200 aligned to the device array area 110 of the lower flexible substrate 100. The fixing unit 320 is disposed on the stage 370 so as to secure an edge of the upper flexible substrate 200 onto the lower flexible substrate 100. The substrate lifting mechanism 330 is disposed over the transmission path A, and is adapted to lift the upper flexible substrate 200 so as to expose the device array area 110. Moreover, the substrate lifting mechanism 330 is adapted to move the upper flexible substrate 200 over the device array area 110. The display medium filling apparatus 350 is disposed over the transmission path A so as to have the device array area 110 filled with a display medium 130. The roller 360 is disposed on the transmission path A and is adapted to perform a rolling-pressing process on the upper flexible substrate 200. Specifically, the conveyer 380 may be disposed over the alignment position B and may move and rotate over the alignment position B according to the present embodiment. Moreover, the alignment unit 310 may also be disposed over the alignment position B, the substrate lifting mechanism 330 and the display medium filling apparatus 350 may be disposed over the filling position C, and the roller 360 may be disposed in front of the filling position C.

Based on the above, the apparatus 300 for aligning and bonding the flexible display panel is capable of being operated under normal pressure, and thus a large-sized vacuum space required for performing a conventional vacuum pump process and the peripheral devices are not necessitated in the present embodiment. In addition, with use of the apparatus 300 for aligning and bonding the flexible display panel, the limitation on adopting the conventional apparatus under a vacuum environment is surmounted, and the flexible display panels can be continuously produced on the transmission path A of the lower flexible substrate 100. Accordingly, the overall production efficiency of said apparatus 300 can be enhanced. Furthermore, since machine equipments for performing the vacuum pump process are not required, the cost for purchasing the machine equipments can then be saved.

According to the present embodiment, a plurality of transmission rollers 390 may allow the lower flexible substrate 100 to move along the transmission path A, while the upper flexible substrate 200 may be temporarily stored on a substrate storage rack 410 aside the alignment position B. The conveyer 380 is adapted to convey the upper flexible substrate 200 from the substrate storage rack 410 to a side of the alignment position B, and, for example, the conveyer 380 may suck and move the upper flexible substrate 200 through vacuum suction. Besides, the conveyer 380 may be connected to a supporting stand 420 which crosses over a part of the transmission path A located between the filling position C and the alignment position B so as to support the conveyer 380.

According to the present embodiment, the substrate lifting mechanism 330 is a vacuum suction member. However, according to other embodiments of the present invention, the substrate lifting mechanism 330 may be a clamp or any other member adapted to lift the upper flexible substrate 200. According to the present embodiment, the fixing unit 320 is a press bar 322, while the fixing unit 320 may also be the clamp or any other device suitable for securing an edge of the upper flexible substrate 200 onto the lower flexible substrate 100 according to other embodiments of the present invention. Moreover, in the present embodiment, the roller 360 may include a soft-surface layer 362 adapted to contact the upper flexible substrate 200 during the rolling-pressing process. A material of the soft-surface layer 362 may include plastic, resin, or foaming material.

The apparatus 300 for aligning and bonding the flexible display panel disclosed in the present embodiment may further include a dispenser 340 disposed over the transmission path A, so as to provide a compound on the lower flexible substrate 100. Particularly, the dispenser 340 may be disposed over the filling position C. Additionally, said apparatus 300 may further include a curing apparatus 430 disposed over the transmission path A and located in front of the roller 360, such that the compound is cured after the upper flexible substrate 200 passes through the roller 360.

According to the present embodiment, the alignment unit 310 may include an image sensor 312. As shown in FIG. 3D, the image sensor 312 may be electrically coupled to a control unit 440 which may be electrically coupled to the conveyer 380. Here, the image sensor 312 is adapted to transmit an image signal to the control unit 440, and the control unit 440 is adapted to control a movement or a rotation of the conveyer 380 based on the image signal, so as to have the upper flexible substrate 200 (referring to FIG. 3C) aligned to the device array area 110 (referring to FIG. 3C). The image sensor 312 may further include a charge coupled device (CCD) or a complementary metal oxide semiconductor (CMOS) sensor. According to other embodiments of the present invention, the alignment unit 310 may include a plurality of the image sensors 312 so as to respectively detect images from multiple pairs of alignment marks 150 and 210 indicated in FIG. 1A.

To sum up, in the method for aligning and bonding the flexible display panel in the present invention, the air bubbles between the upper flexible substrate and the lower flexible substrate are expelled through the rolling-pressing process performed by the roller, such that the upper and the lower flexible substrates are bonded together under normal pressure. Hence, in comparison with the related art, the method for aligning and bonding the flexible display panel in the present invention can be carried out in a non-vacuum environment, which effectively reduces the manufacturing cycle time. In addition, with use of the apparatus for aligning and bonding the flexible display panel disclosed in the invention, the limitation on adopting the conventional apparatus under a vacuum environment is surmounted, and the flexible display panels can be continuously produced on the transmission path of the lower flexible substrate. Thereby, the apparatus for aligning and bonding the flexible display panel disclosed in the invention significantly improve the efficiency of fabrication. Further, the large-sized hermetic space required for performing a conventional vacuum pump process and the peripheral devices are not necessitated in the apparatus for aligning and bonding the flexible display panel disclosed in the present invention. The expenses of the machine equipments can also be saved by employing the apparatus for aligning and bonding the flexible display panel disclosed in the present invention.

Although the present invention has been disclosed above by the preferred embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A method for aligning and bonding a flexible display panel, comprising:
providing a lower flexible substrate and an upper flexible substrate, wherein the lower flexible substrate comprises a device array area;
covering the upper flexible substrate on the device array area and having the upper flexible substrate aligned to the device array area;
securing an edge of the upper flexible substrate onto the lower flexible substrate;
lifting the upper flexible substrate to expose the device array area;
providing a display medium on the device array area;
laying the upper flexible substrate back over the device array area; and
bonding the upper flexible substrate to the lower flexible substrate by a roller, such that the display medium is sealed therebetween.

2. The method of claim 1, wherein the upper flexible substrate is aligned to the device array area through image recognition technology.

3. The method of claim 1, wherein the upper flexible substrate is lifted through vacuum suction or clamping.

4. The method of claim 1, further comprising coating a sealant at a periphery of the device array area after the upper flexible substrate is lifted, and the sealant encompasses the display medium after the display medium is provided on the device array area.

5. The method of claim 4, further comprising curing the sealant with use of a curing apparatus after bonding the upper flexible substrate to the lower flexible substrate.

6. The method of claim 4, wherein a material of the sealant comprises light curable material, thermal curable material, photoresist material, or a compound that is self-curable under normal temperature.

7. The method of claim 1, wherein a surface of the lower flexible substrate comprises a wall structure, at least a part of the wall structure surrounding the device array area, at least a part of the wall structure surrounding the display medium after the display medium is provided on the device array area.

8. The method of claim 7, further comprising coating an adhesive on the wall structure after the display medium is provided on the device array area.

9. The method of claim 8, further comprising curing the adhesive with use of a curing apparatus after bonding the upper flexible substrate to the lower flexible substrate.

10. The method of claim 8, wherein a material of the adhesive comprises light curable material, thermal curable material, photoresist material, or a compound that is self-curable under normal temperature.

11. The method of claim 1, wherein the device array area is filled with the display medium through one drop fill process, coating, or inkjet printing.

12. The method of claim 1, wherein the display medium comprises a liquid crystal medium or a particle medium, the liquid crystal medium comprising semectic liquid crystals, nematic liquid crystals, cholesteric liquid crystals or discotic liquid crystals, the particle medium comprising electrophoretic particles or Rotating sphere.

13. The method of claim 1, wherein the lower flexible substrate is suitable for enabling the upper flexible substrate to pass through the roller, such that the upper flexible substrate and the lower flexible substrate are bonded through performing a rolling-pressing process on the upper flexible substrate.

14. The method of claim 1, wherein the lower flexible substrate and the upper flexible substrate are transmitted in a manner of patching or reel to reel.

15. An apparatus for aligning and bonding a flexible display panel, the apparatus being adapted to fill a display medium between a lower flexible substrate and an upper flexible substrate and to bond the lower flexible substrate to the upper flexible substrate, wherein the lower flexible substrate is adapted to move forward along a transmission path, the apparatus comprising:
a stage used to support the lower flexible substrate and adapted to move back and forth on the transmission path;
a conveyer disposed over the transmission path so as to convey the upper flexible substrate onto the lower flexible substrate;
an alignment unit disposed over the transmission path so as to have the upper flexible substrate aligned to a device array area of the lower flexible substrate;
a fixing unit disposed on the stage so as to secure an edge of the upper flexible substrate onto the lower flexible substrate;
a substrate lifting mechanism disposed over the transmission path, wherein the substrate lifting mechanism is adapted to lift the upper flexible substrate so as to expose the device array area, and the substrate lifting mechanism is adapted to move the upper flexible substrate over the device array area;
a display medium filling apparatus disposed over the transmission path so as to have the device array area filled with a display medium; and
a roller disposed on the transmission path and adapted to perform a rolling-pressing process on the upper flexible substrate.

16. The apparatus of claim 15, comprising a plurality of transmission rollers adapted to move the lower flexible substrate along the transmission path.

17. The apparatus of claim 15, wherein the alignment unit comprises at least an image sensor.

18. The apparatus of claim 17, further comprising a control unit electrically coupled to the conveyer and to the image sensor, wherein the image sensor is adapted to transmit an image signal to the control unit which is adapted to control an operation of the conveyer based on the image signal.

19. The apparatus of claim 15, wherein the stage is adapted to move to an alignment position and a filling position on the transmission path, the filling position being located in front of the alignment position, the conveyer and the alignment unit being disposed over the alignment position, the substrate lifting mechanism and the display medium filling apparatus being disposed over the filing position, the roller being disposed in front of the filing position.

20. The apparatus of claim 19, further comprising a supporting stand crossing over a part of the transmission path located between the filling position and the alignment position, the conveyer being connected to the supporting stand.

21. The apparatus of claim 19, further comprising a substrate storage rack disposed aside the alignment position so as to store the upper flexible substrate, the conveyer being adapted to convey the upper flexible substrate from the substrate storage rack over the alignment position.

22. The apparatus of claim 15, further comprising a dispenser disposed over the transmission path so as to provide a compound onto the lower flexible substrate.

23. The apparatus of claim 22, further comprising a curing apparatus disposed over the transmission path and located in front of the roller so as to cure the compound.

24. The apparatus of claim 15, wherein the substrate lifting mechanism comprises a vacuum suction member or a clamp.

25. The apparatus of claim 15, wherein the roller comprises a soft-surface layer which is adapted to contact the upper flexible substrate.

26. The apparatus of claim 25, wherein a material of the soft-surface layer comprises plastic, resin, or foaming material.
